(19) United States
(12) Patent Application Publication
(10) Pub. No.: US 2014/0137715 A1
(43) Pub. Date: May 22, 2014

(54) MICROTOME CHAMBER, SAMPLE HOLDER AND SAMPLE PROCESSING METHOD

(71) Applicants: VIB VZW, Gent (BE); PIERA BVBA, Turnhout (BE); Katholieke Universiteit Leuven, K.U.Leuven R&D, Leuven (BE); IMEC, Leuven (BE)

(72) Inventors: Emmanuel Sneyders, Turnhout (BE); Hans Nicasy, Turnhout (BE); Bruce Leslile Mcnaughton, Lethbridge (CA)

(21) Appl. No.: 14/125,568

(22) PCT Filed: Jun. 14, 2012
(86) PCT No.: PCT/EP2012/061372

§ 371 Date: Dec. 11, 2013

(30) Foreign Application Priority Data
Jun. 14, 2011 (GB) 1109999.1

(51) Int. Cl. B26D 7/01

(52) U.S. Cl. CPC B26D 7/01
USPC 83/24; 83/167

(57) ABSTRACT

The disclosure relates to the automatic staining, imaging, cutting and collection of samples in a sample-processing device, in particular in a microtome. It provides a general-purpose sample holder, which comprises fluid exchange means for, e.g., surface staining and washing of a specimen. Furthermore, it provides a microtome chamber comprising sample collection means. A directional flow is used in the microtome chamber to transport a cut section of the specimen to a sample collection chamber. The present microtome chamber is especially useful to automatically collect delicate microtome samples, such as thin fresh tissue slices prepared by a vibratome. The microtome chamber may further comprise a sample holder receptacle and means to transport fluids to and from the fluids exchange means of the sample holder.

### CROSS-REFERENCE TO RELATED APPLICATION

This application is a national phase entry under 35 U.S.C. §371 of International Patent Application PCT/EP2012/061372, filed Jun. 14, 2012, designating the United States of America and published in English as International Patent Publication WO2012/172024 A1 on Dec. 20, 2012, which claims the benefit under Article 8 of the Patent Cooperation Treaty to United Kingdom Application Serial No. 1109999.1, filed Jun. 14, 2011.

### TECHNICAL FIELD

The disclosure relates to the automatic staining, imaging, cutting and collection of samples in a sample processing device, in particular in a microtome. It provides a general-purpose sample holder, which comprises a plunger onto which a sample can be immobilized and a shaft that encases the plunger. The removable sample holder can be connected to a variety of instruments, including microtomes and microscopes. The sample holder is further characterized in that it comprises means to connect the plunger to a micrometer drive, allowing axial movement of the plunger in the shaft. It further comprises fluid exchange means for embedding a sample in a gelling or hardening material; for diffusing a liquid into a sample; or for surface staining and washing of a specimen.

Described is a microtome chamber comprising sample collection means. A directional flow (hereinafter also referred to as a vectorized flow) is used in the microtome chamber to transport a cut section of the specimen to a sample collection chamber. The sample holder and the microtome chamber are compatible with a variety of microtomes, including vibratory microtomes, ultramicrotomes and laser microtomes. The present microtome chamber is especially useful for automatically collecting delicate biological samples, such as thin (below 50 micron) fresh tissue slices prepared by a vibratome. The microtome chamber may further be adapted to accommodate the sample holder. Therefore, the chamber comprises a sample holder receptacle and means to transport fluids to and from the fluids exchange means of the sample holder.

In this regard, the disclosure is especially useful to analyze tissue features along the depth of a sample in an automated manner. This analysis involves iterative steps of staining the surface of a sample, imaging this surface and cutting a section from the sample to reveal a new surface.

### BACKGROUND

Imaging of histological samples is generally undertaken on sections or slices of samples that have been mounted on slides and then stained to reveal features within each sample slice. However, distortion of the slices occurs, for example, due to shrinkage or tearing of sections, causing a degree of misalignment between successive slices. Also, in complex three-dimensional objects, slice integrity is often not maintained. These factors complicate analysis of the features within the sample. Fiducial markers have been introduced into the sample prior to sectioning so that the distortion can be compensated for; however, these sometimes damage the sample itself. Of major importance, the sample preparation and subsequent image analysis is very time consuming and difficult to automate.

An improvement to this conventional imaging method uses block-face imaging and comprises surface staining to reveal the tissue structure of a sample, with the uppermost surface of the sample being imaged as successive sections are in turn cut and removed. By imaging the upper surface of the sample before removing a thin slice to reveal the next surface of the sample, distortion and loss of integrity effects between the different images are avoided. The generated images can therefore be used to generate a three-dimensional image of the sample tissue. However, the resolution of features within the sample tissue is limited due to penetration of the stain, as the depth of penetration of the stain restricts how deep the sample can be analyzed.

A solution to this problem is partially given by the optical imaging method provided in U.S. Pat. No. 7,767,414, as shown in FIG. 1. This method uses iterative steps of staining the sample (100 in FIG. 1A), imaging the sample with an imaging apparatus (340 in FIG. 1A) and removing a thin slice from the sample by a knife (315 in FIG. 1A). Nevertheless, automated staining of the sample with this method is complex, as it involves horizontal and vertical movements to bring the stain tray into contact with the sample for dipping. Furthermore, this method cannot be used in a vibratory microtome, wherein the sample is submerged in water or buffered medium during cutting. In addition, the microtome cannot be used with other samples during staining, which is especially a nuisance when prolonged incubation times are needed to stain the sample.

An improved sample holder is presented in U.S. Pat. No. 5,550,033, as shown in FIGS. 2A and 2B. This sample holder comprises a plunger (22 in FIGS. 1B and 1C) that is insertable in a mould (14 in FIG. 1B). The plunger has a surface (25 in FIGS. 1B and 1C) to bond with a sample (27 in FIGS. 1B and 1C) embedded in a gelatinous material. A cradle (11 in FIG. 1B) can be used to prepare or store multiple samples simultaneously. The plunger, together with the embedded sample can be removed from the mould and inserted in a microtome tissue well (41 in FIG. 1C). Nonetheless, this disclosure does not indicate the possibility of removal and reconnection of the same sample from the microtome. Furthermore, even if removal and reconnection of a sample is possible, this construction is prone to several problems. Since rotation of the sample holder is not prevented, reorientation of the sample can occur during the removal and repositioning the sample holder. Moreover, the sample holder does not retain how deep the sample protruded in the microtome before removal, making it difficult to reposition the sample correctly. Furthermore, removal of the plunger with the sample from the mould and connection of these components to the microtome well is a delicate task when the sample is a soft tissue embedded in soft material. In addition, no means are provided to connect the sample holder to other instruments for staining, imaging or other biological analysis methods.

Similarly, U.S. Pat. No. 7,146,895 provides a vibratory microtome with a removable specimen syringe, as shown in FIG. 1D. An embedded sample (148 in FIG. 1D) is fixed to a plunger (140 in FIG. 1D) that is located in a hollow shaft. The sample is pushed past the compressed lip of the syringe (132 in FIG. 1D) into a buffer bath (120 in FIG. 1D), where a blade (168 in FIG. 1D) cuts the sample. Although the drawings suggest that the axial position of the sample can be retained in the sample holder during removal and repositioning (due to a spacer ring 128 and a stopper 129), rotation of the sample holder is not prevented. In addition, and similar to the disclosure above, no means are provided to connect the sample holder to other instruments for staining, imaging or other biological analysis methods. Furthermore, U.S. Pat. No. 7,146,895 specifically states that the syringe end is narrowed to apply force on the sample when it is pushed past the compressed lip of the syringe. This extrusion process may damage delicate samples.

Another specific problem when performing iterative steps of staining, imaging and sectioning a sample in a microtome where the sample is submerged when cut, is that cut sections stay in the surrounding liquid and may interfere with the subsequent steps. Furthermore, it is often desirable to collect cut sections for further analysis, in an organized way. Before the current disclosure, no automated collection of delicate sections (e.g., fresh tissue slices with a thickness below 50 micron as prepared by a vibratome) was known.

U.S. Pat. No. 5,522,294 provides a microtome wherein a sample is placed below a plunger (31 in FIG. 1E) within a tissue block (21 in FIG. 1E). The whole tissue block oscillates over a knife, which leads to the removal of a section that is collected in a collection tube (90 in FIG. 1E). However, amongst others due to the oscillation of the whole tissue block, the microtome of U.S. Pat. No. 5,522,294 contains a large number of moving components and does not allow the creation of very thin slices (e.g., 20-40 micron) with a consistent thickness. In addition, the microtome does not allow surface imaging and/or staining of the samples between the iterative step of slicing and removal of subsequent slices.

### BRIEF SUMMARY

Provided is a sample holder (1) comprising:

a plunger with a sample anchor, and
a shaft, which is open-ended at an upper and lower end, and that in sealing relation encases the plunger,
the sample holder being characterized in that
the shaft comprises connection means,
the sample holder comprises fluids exchange means, and
the plunger comprises means to interact with a micrometer drive.

This sample holder is particularly useful when connected to a variety of instruments, especially a microtome or a microscope. The sample holder, according to the disclosure, is in particular suitable for use in a microtome chamber, according to the disclosure.

In a further embodiment of the disclosure, the sample holder, according to the disclosure, may further comprise sealing means to prevent fluid leakage between the plunger and the shaft, in a particular embodiment the sealing means are one or more sealant rings.

In a particular embodiment, the sample holder, according to the disclosure, is further characterized in that the connection means at the shaft of the sample holder are located at the lower end of the sample holder.

In principle, the connection means at the shaft of the sample holder can take any form suitable to assure proper positioning and fixation of the sample holder at the sample holder position of the desired apparatus, such as at the sample holder position in a microtome. Typically, these connection means will cooperate with the sample holder receptacle present at the sample holder position of the desired apparatus. Taken together the connection means at the shaft of the sample holder and the sample holder receptacle present at the sample holder position of the desired apparatus, form the sample holder connector to immobilize the shaft of the sample holder at the sample holder position of the desired apparatus. The sample holder connectors, as used herein, include, but are not limited to, twist-lock connectors, friction locks, screw-threaded connectors, magnetic connectors, and connectors using coupling pins.

In a particular embodiment, the connection means are connected to or are part of the shaft and comprises one or more elements selected from the group comprising: a magnet, a thread, a protrusion, and a notch.

In a particular embodiment, the sample holder connector is a twist-locking connector. In the embodiment, the sample holder, according to the disclosure, is further characterized in that the connection means comprises one or more elements protruding from the shaft.

In operation, firm binding of the sample to the plunger is of utmost importance. Consequently, and as already provided hereinbefore, the plunger of the sample holder, according to the disclosure, is characterized in that it comprises means to anchor the sample to the plunger, in a particular embodiment of the disclosure, the sample anchor of the sample holder comprises a face for immobilizing a sample to the plunger.

In yet another embodiment, the face from the sample anchor of the sample holder, according to the disclosure, comprises one or more of the following features: a rough surface, a surface containing grooves, or a mesh.

In another particular embodiment, the sample anchor of the sample holder, according to the disclosure, comprises a mesh that is connected to the top end of the plunger with one or more spacers.

In another particular embodiment, the mesh, as described hereinbefore, is made from a material selected from the group comprising metal, plastic, and textile.

In yet another particular embodiment, the shaft and the plunger, according to the disclosure, are made from a material each independently selected from metal or plastic.

In another particular embodiment, the plunger and the shaft, as defined hereinbefore, are not cylindrical, in particular, the cross-section of the plunger and the shaft consists of an elongated circle.

Precise axial movement of the plunger is a necessity in a microtome, as this movement prescribes the thickness of the section that will be cut. Thus, it is important that the plunger can be securely attached to a micrometer drive while axially moving in the shaft. A micrometer drive is here defined as a combination of an element (electromotor/gearbox, . . . ) that can be mechanically displaced with micrometer precision, together with all elements that transmit this movement with micrometer precision from the element that can be mechanically displaced with micrometer precision to the plunger of the sample holder. Therefore, in a particular embodiment, the means to interact with a micrometer drive are connected to or are part of the plunger and typically comprises one or more elements selected from the group comprising: a thread, a protrusion, and a notch.

In a particular embodiment of the disclosure, the sample holder, according to the disclosure, comprises an identifier. This identifier may aid in differentiating different sample holders and the samples they contain.

In another embodiment, the sample holder, according to the disclosure, is further characterized in that the fluids exchange means are located at the upper region of the sample holder. Fluids exchange is typically performed when the sample holder is not submerged. If the sample holder is submerged, and in order to enable fluid exchange in the sample holder, the liquid level in the microtome chamber is first lowered below the top of the sample holder. Subsequently, by lowering the sample in the shaft, an empty cavity is created in the upper region of the shaft above the surface of the sample. Fluids exchange means are located within this upper region and can now be used to perform all the processing steps for embedding a sample, diffusion of liquids into the sample, or staining the surface of the sample. When no staining is to be performed, the empty cavity in the upper region of the shaft above the surface of the sample can still be filled with a liquid, e.g., the liquid from the microtome chamber. This allows the sample to be continuously in contact with a liquid during all processing steps, including imaging, which is especially useful for live biological samples or samples that are maintained in a hydrated state.

Further provided is a microtome chamber comprising:

a sample holder, which is in a fixed position during cutting;
means to generate a directional flow; and
a sample collection chamber comprising a sample inlet.

Also provided is a microtome chamber, which is adapted to accommodate the sample holder defined hereinbefore, wherein the microtome chamber comprises:

a sample holder receptacle,
a fluid inlet and outlet,
means to connect the microtome chamber to a microtome,
means to allow a connection between a micrometer drive and the micrometer drive connection,
means of the plunger of the sample holder.
the microtome chamber further being characterized in that it comprises:
means to generate a vectorized flow, and
sample collection means.

Within the context of the disclosure, the sample holder receptacle is compatible with the sample holder connection means, as defined hereinbefore. Taken together with the sample holder connection means, the sample holder receptacle forms a sample holder connector that assures proper positioning and fixation of the sample holder at the sample holder position of the microtome chamber. The connector is typically selected from the group comprising a twist-lock connector, a friction lock, a screw-threaded connector, a magnetic connector, and a connector that uses coupling pins.

In a particular embodiment, the connector is a twist-lock connector.

When the sample holder is used in a microtome where the sample is submerged in a liquid when cut, it is important that the liquid level is lowered below the top of the sample holder before the liquid exchange system is used. Therefore, in a particular embodiment, the microtome chamber, according to the disclosure, is further characterized in that it comprises means to regulate the fluid level in the microtome chamber.

Debris may be formed from cutting the sample. This debris generally floats to the surface of the liquid or sinks to the bottom of the microtome bath. Therefore, a particular embodiment provides a microtome chamber, according to the disclosure, that further comprises means to remove debris formed from cutting the sample from the chamber. In a first aspect, the means (14) will be located at the liquid surface to remove floating debris from the chamber and typically consists of surface suction means. In another aspect the means (16) will be located at the base of the chamber to remove sunken debris from the chamber and typically consists of bottom suction means. In a particular embodiment, both are present to remove debris from the microtome chamber and the chamber is further characterized in that it comprises surface (14) and bottom (16) debris removal means.

When analyzing a biological sample, temperature control of the microtome chamber and its components and content is often needed. Hence, another particular embodiment provides a microtome chamber, according to the disclosure, further comprising temperature control means.

After a section is cut from the sample, it needs to be removed from the region around the top of the sample holder, to ensure that the section does not interfere with subsequent staining, imaging and cutting steps of the exposed sample surface. Therefore, the microtome chamber, according to the disclosure, provides means to generate a vectorized flow (25). In particular, a vectorized flow is meant to be a directional flow. Thus, the vectorized flow is an organized flow, such as a substantially laminar flow, to carry the slice into a desired direction. This vectorized flow will create a current over and around the top of the sample holder and thereby drag the cut section along with it. In a particular embodiment, the means to generate a vectorized flow comprises a perforated wall in front of a fluid inlet. In another particular embodiment, a spray system is provided to flush a cut section from the knife or the sample.

To negate the need for the time consuming process of manually removing sections from the microtome bath one by one, the microtome chamber, according to the disclosure, provides sample collection means to trap the section that is transported by the vectorized flow. In particular, the sample collection means of the disclosure comprises a sample collection chamber (24a) comprising a sample inlet (36). In a particular embodiment, the sample collection means comprises a mesh well. In another particular embodiment, the sample collection means further comprises a funnel.

In a particular embodiment of the disclosure, the sample collection means, according to the disclosure, comprises an identifier. This identifier may aid in differentiating different sample collection means and the sample sections they contain.

In another embodiment, the microtome chamber, according to the disclosure, comprises means to replace the sample collection chamber with a new sample collection chamber in an automated manner, such as, for example, with a robotic arm, or with a carrousel comprising a plurality of sample collection chambers.

In yet another embodiment, the microtome chamber, according to the disclosure, further comprises means to exchange fluids within the sample holder, as defined hereinbefore. The means are compatible with the fluid exchange means of the sample holder, and allow a fluid-tight connection between the sample holder and an external fluid exchange system to perform all the processing steps for embedding a sample, diffusion of liquids into the sample, or staining the surface of the sample.

In another particular embodiment, the microtome chamber, according to the disclosure, is further characterized in that it comprises means to recognize an identifier on the sample holder, as described hereinbefore. In yet another particular embodiment, the microtome chamber, according to the disclosure, comprises means to recognize an identifier on the sample collection means, as described hereinbefore. In case the microtome chamber, according to the disclosure, comprises means to recognize an identifier on the sample holder as well as the sample collection means, a processing unit that receives this information can be used to link collected sample sections through the identifiers to the original sample holder and thereby to the original sample.

The instant disclosure provide a means for automated surface staining of a sample that relies on a limited number of mechanical movements and that is compatible with different instruments, including, but not limited to, microscopes and microtomes, e.g., microtomes wherein the sample is submerged when cut. The instant disclosure provides a sample holder that allows a sample to be substantially continuously into contact with a liquid during processing steps. This is especially useful for live biological samples and samples that are prone to dehydration.

Provided is an improved sample holder that can be connected easily to different instruments and that can be disconnected easily for storage, all while maintaining the positioning of the sample and while preventing sample damage. Further disclosed are means for automating the removal of cut sections from the region surrounding the sample. In addition, the instant disclosure collects the sections to allow further processing, negating the need to manually remove sections one by one from the microtome bath, a time consuming process that is currently used in vibratory microtomes. In particular, provided is a microtome bath that allows block-face imaging during slicing of delicate tissue and automatic collection of the cut sections.

### BRIEF DESCRIPTION OF THE DRAWINGS

With specific reference now to the figures, it is stressed that the particulars shown are by way of example and for purposes of illustrative discussion of the different embodiments of the disclosure, only. They are presented in the cause of providing what is believed to be the most useful and readily description of the principles and conceptual aspects of the disclosure. In this regard no attempt is made to show structural details of the disclosure in more detail than is necessary for a fundamental understanding of the disclosure. The description taken with the drawings make it apparent to those skilled in the art how the several forms of the disclosure may be embodied in practice.

FIG. 1A: Representation of a prior art approach to automated specimen imaging (U.S. Pat. No. 7,767,414).

FIG. 1B: Representation of a prior art sample holder (U.S. Pat. No. 5,550,033)

FIG. 1C: Representation of a prior art sample holder placed in a microtome well (U.S. Pat. No. 5,550,033).

FIG. 1D: Representation of a prior art microtome with a syringe sample holder (U.S. Pat. No. 7,146,895).

FIG. 1E: Representation of a prior art microtome with a sample collection tube (U.S. Pat. No. 5,522,294).

FIG. 2A: Cross-sectional view of a representation of a sample holder according to the disclosure.

FIG. 2B: Top view of a representation of a sample holder according to the disclosure.

FIG. 3: Cross-sectional side view of a sample holder placed in a microtome chamber according to the disclosure.

FIG. 4: Cross-sectional side view of a sample holder placed in a microtome chamber, which is connected to a microtome according to the disclosure.

FIG. 5: Cross-sectional front view of a representation of a sample holder placed in a microtome chamber according to the disclosure.

FIG. 6: Automated mesh well replacement means, which are connected to a microtome chamber according to the disclosure.

FIG. 7: Cross-sectional side view of a sample collection chamber and sample collection container.

FIG. 8: Overview figure of a microtome chamber and sample holder, according to the disclosure.

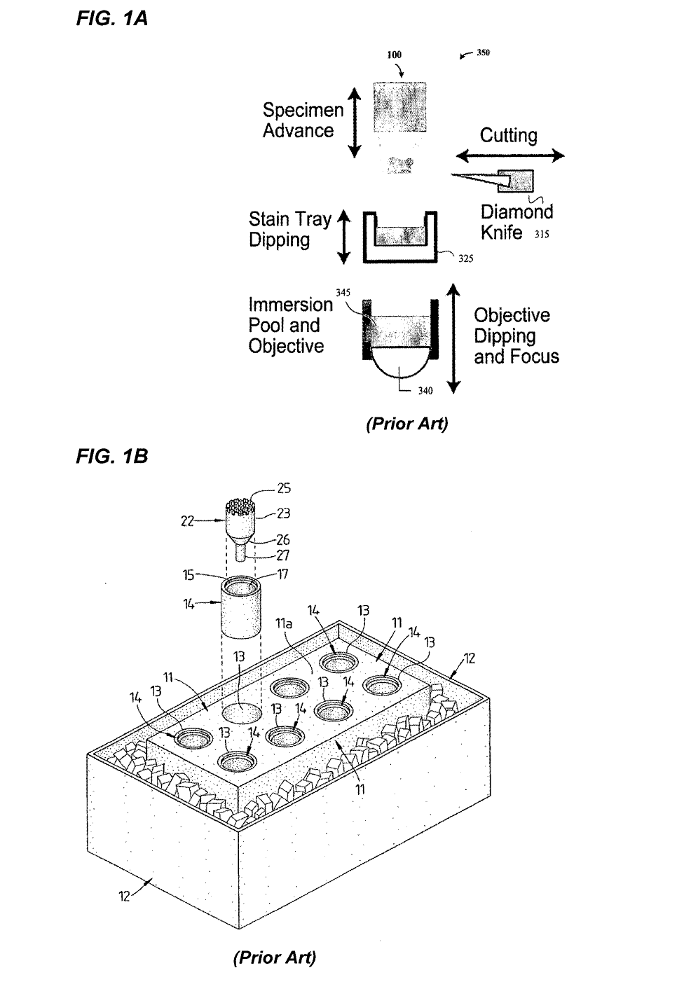

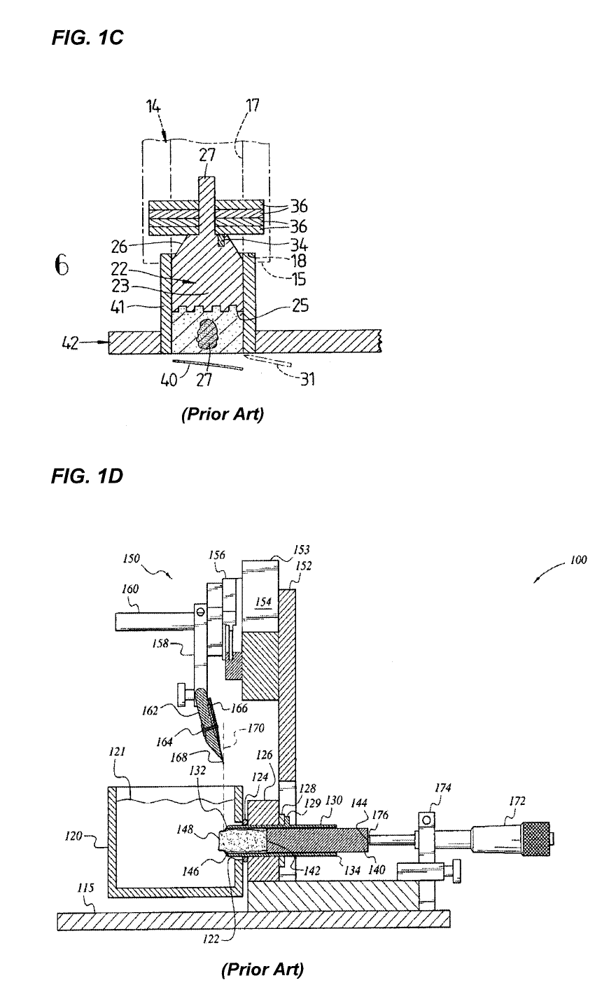

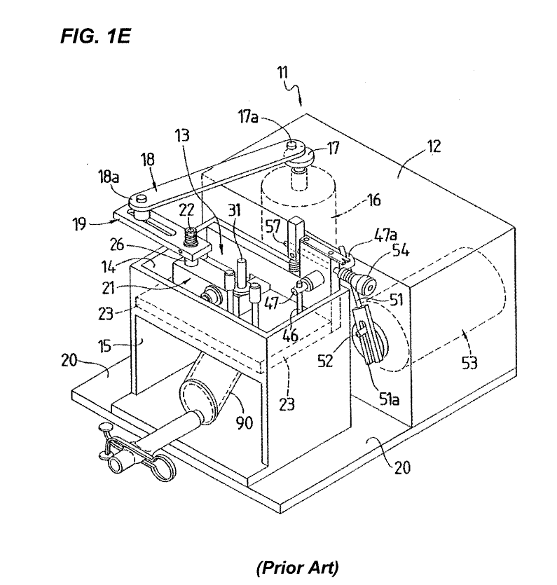

### DETAILED DESCRIPTION

Imaging methods using surface staining to reveal the tissue structure of a sample, with the uppermost surface of the sample being imaged as successive sections are in turn cut and removed provide valuable information on the tissue structure along a depth of the sample. However, the resolution of features within the sample tissue is limited due to penetration of the stain, as the depth of penetration of the stain restricts how deep the sample can be analyzed. Current methods to iteratively stain, image, and cut a sample are complex and incompatible with vibratory microtomes and with samples that need to be in contact with a liquid during all processing steps, such as, for example, a live biological sample. Furthermore, the microtome cannot be used with other samples during staining, which is especially a nuisance when prolonged incubation times are needed to stain the sample.

Therefore, one can appreciate that the sample holder, according to the disclosure, provides a means for automated surface staining of a sample that relies on a limited number of mechanical movements. Furthermore, the sample holder is compatible with different instruments, including, but not limited to, microscopes and microtomes, for example, microtomes wherein the sample is submerged when cut. The sample holder can be connected easily to different instruments and can be disconnected easily for sample preparation, sample analysis, and storage, all while maintaining the positioning of the sample and while preventing sample damage.

Within the scope of the disclosure, a sample refers to a biological specimen. A sample comprises one or more elements selected from the group comprising a cell, a part of or a complete tissue, a part of or a complete organ, and a part of or a complete tumor. A sample may be from human origin, or derived from mouse, rat, rabbit, guinea pig, or any vertebrate, invertebrate, or plant. Therefore, a sample may be a soft tissue, such as the brain of a mouse. Staining can be performed with any stain. Typically, stains include, but are not limited to, one or more elements selected from the group comprising quantum-dot stains; organic stains; and fluorescent-type stains, such as fluorescent dyes and fluorescent proteins. Furthermore, staining can be performed using successive staining steps that may be intermitted with one or more washing steps. Sections that are removed can have any thickness; typically, they have a thickness from 5 to 2000 micrometers.

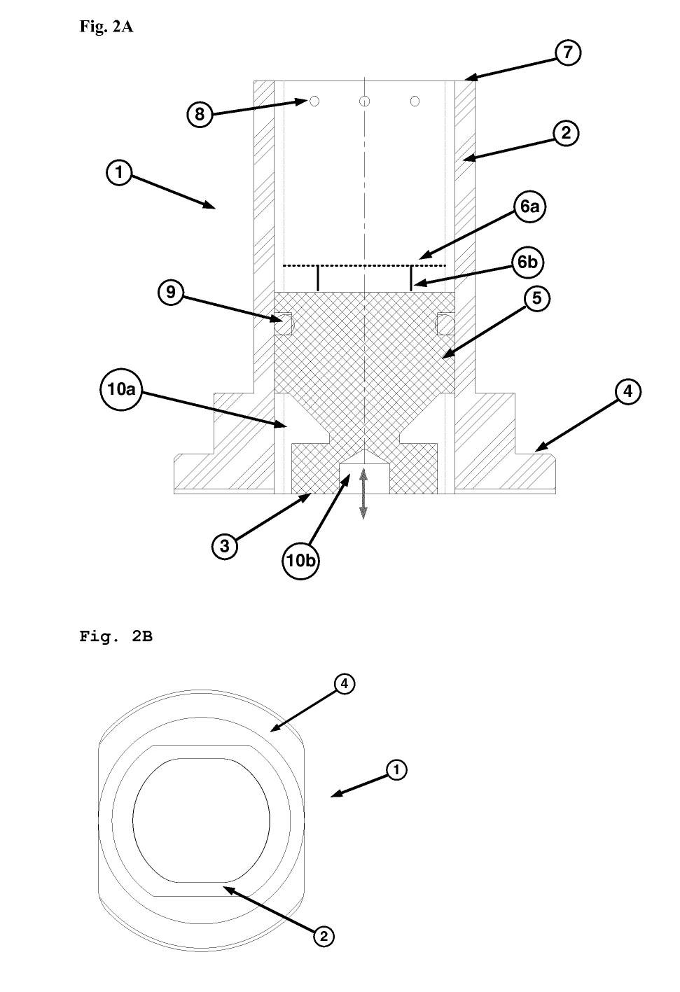

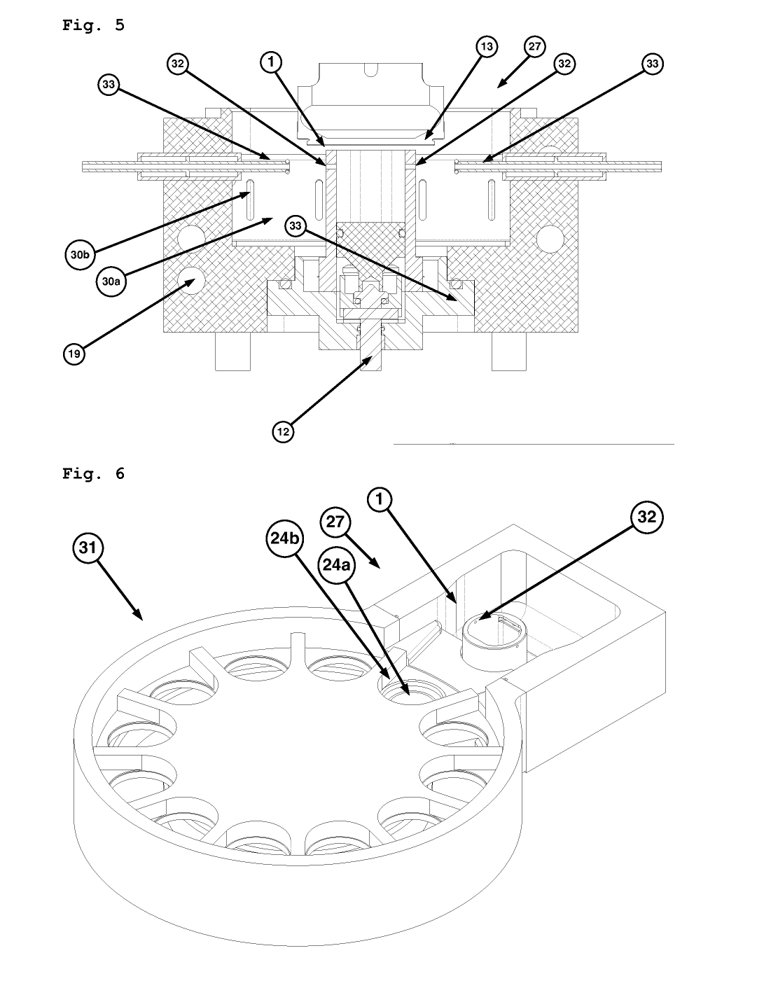

Different embodiments of the sample holder, according to the disclosure, are shown in FIGS. 2 to 5, and are further specified herein below.

Referring to FIGS. 2A and 2B, the disclosure provides a sample holder (1) comprising:

a plunger (5) with a sample anchor (6a and 6b),
a shaft (2), which is open-ended at an upper and lower end, and that in sealing relation encases the plunger,
the sample holder being characterized in that
the shaft comprises connection means (4), and
the sample holder comprises fluids exchange means (8).

In a particular embodiment, the plunger comprises means to interact with a micrometer drive (10a and 10b).

Sample preparation for use of the sample in a microtome often requires embedding the sample in a hardening or gelling agent. Frequently used embedding agents for subsequent usage in a microtome include agar, egg yolk, gelatin and paraffin. When the sample preparation is performed in the sample holder, it is important to prevent leakage of the embedding agent in the sample holder. Leakage prevention is also important during other processes that involve liquids; including diffusion of a liquid in the sample, during staining, and when the sample holder is submerged in a liquid. Leakage may be prevented by a narrow fit of the plunger in the shaft.

In a particular embodiment, the sample holder, according to the disclosure, comprises sealing means to prevent fluid leakage between the plunger and the shaft. The sealing means can be any suitable sealant, including a sealing gel, sealing rings, and a sealing plunger head.

In a further particular embodiment, the sealing means are one or more sealant rings, as shown in FIG. 2A (9). The sealing rings can be made from any suitable material known in the art, such as, for example, but not limited to, plastic, silicone and rubber.

In another embodiment, the sample holder, according to the disclosure, is further characterized in that the connection means (4), as defined hereinbefore, are located at the lower end of the sample holder (3), as shown in FIGS. 2A and 2B.

As stated hereinbefore, it is of the utmost importance that the sample can be immobilized on the plunger during operation. This prevents the sample to loosen from the plunger, for example, during travel of the plunger in the shaft in-between staining and cutting steps. Furthermore, immobilization of the sample is important to maintain the horizontal, vertical and rotational orientation of the sample in relation to the sample holder. In a particular embodiment, the sample anchor, as described hereinbefore, comprises a face for immobilizing a sample to the plunger. Immobilization may be performed by gluing the sample to the face, or by the interaction of the face with embedding material. The sample anchor may be reversibly attached to the plunger to allow different types of sample anchors to be connected to the plunger and to allow worn-out sample anchors to be replaced. The user of the sample holder, as hereinbefore defined, may choose between different types of the sample anchors, according to the disclosure, based on the properties of the sample.

In yet another embodiment, the face from the sample anchor of sample holder, according to the disclosure, comprises one or more of the following features: a rough surface, a surface containing grooves, pins or a mesh.

Referring to FIG. 2A, in another particular embodiment, the sample anchor comprises a mesh (6a) that is connected to the top end of the plunger with one or more spacers (6b). A spacer can be made from a material selected from the group comprising metal and plastic. The spacer or spacers provide a space between the mesh and the top end of the plunger, thereby allowing part of the embedding material to enter this space through the mesh. After the hardening or gelling of the embedding material, the embedded sample is immobilized on the mesh and, thus, also on the plunger.

The mesh, as described hereinbefore, may be made from a material selected from the group comprising metal, plastic, and textile; in particular stainless steel or aluminum.

In yet another particular embodiment, the shaft and the plunger, according to the disclosure, are made from a material each independently selected from metal or plastic, in particular stainless steel, aluminum, ABS, PMMA, PUR, PA, PE, PTFE, UP, polyester, polyamide or PVC.

In another embodiment, surfaces of one or more elements from the sample holder, according the disclosure, may be completely or partly coated to reduce friction, increase resistance to scratches, increase resistance to corrosion, or increase or lower adhesion properties. Any suitable coating can be used, in particular, the coating is one or more elements selected from the group consisting of ceramic, titanium nitride (TiN), titanium carbonitride (TiCN), aluminum chromium nitride (AlCrN), titanium aluminum nitride (TiAlN), and Tungsten Carbide/Carbon (WC/C) coatings.

In another particular embodiment, sample holders, according to the disclosure, are provided with different specifications to create a range of sample holders. This allows a user to choose a specific sample holder in relation to the type of experiment that is to be performed. Different specifications include, but are not limited to: different circumference sizes of the plunger, different allowable travel ranges of the plunger in the shaft, and different materials that are used in the sample holder. In a particular embodiment, the different internal circumference sizes of the plunger can be from about 50 mm to about 300 mm, in particular about 50 mm, 75 mm, 100 mm, 125 mm, etc., which can be selected to accommodate samples of different size. In another particular embodiment, the different allowable travel ranges of the plunger in the shaft can be from about 10 mm to about 80 mm, in particular about 20 mm, 30 mm, 40 mm, etc., which can be selected to accommodate samples of different size. In yet another particular embodiment, the shaft and plunger can be made from plastic, to allow the sample holder to be submitted to microwave heating. In yet another particular embodiment, the shaft and the plunger can be made from any autoclavable material, to allow autoclaving of the sample holder components.

When analyzing sample features along the depth of the sample, it is important that the positioning of the sample is maintained during processing steps. Therefore, it is important that the positioning of the plunger in relation to the shaft is maintained during operation, when connecting and disconnecting the sample holder from the sample holder connector, and when the sample holder is not connected to a connector. Therefore, in a particular embodiment, the plunger and the shaft, as defined hereinbefore, are not cylindrical. In particular, a cross-section of the interface between the plunger and the shaft consists of an elongated circle, as can be seen in FIG. 2B. This serves to block the rotation of the plunger in the shaft.

In a further aspect, and in order to assure a consistent positioning of the sample in the sample holder, it should be feasible for the plunger of the sample holder, according to the disclosure, to be connected with a micrometer drive in a unique relationship. Therefore, the plunger is connected to or comprises means to interact with a micrometer drive, the means to interact with a micrometer drive comprising or more elements selected from the group comprising: a thread, a protrusion, and a notch.

In another embodiment, the sample holder, according to the disclosure, provides an identifier. This identifier facilitates to differentiate different sample holders and their contents from one another. Any identifier may be used, including a combination of one or more elements selected from the group comprising numbers, symbols, letters, barcodes, two-dimensional barcodes, and radio-frequency identification tags.

In a particular embodiment, the fluids exchange means located at the upper region of the sample holder, comprises one or more holes through the shaft (32 in FIG. 6). In particular, these holes have a diameter from about 1 mm to about 5 mm and are perpendicularly orientated in the shaft.

In yet another particular embodiment, the sample holder, according to the disclosure, is suitable for use in a microtome chamber, as described hereinbelow.

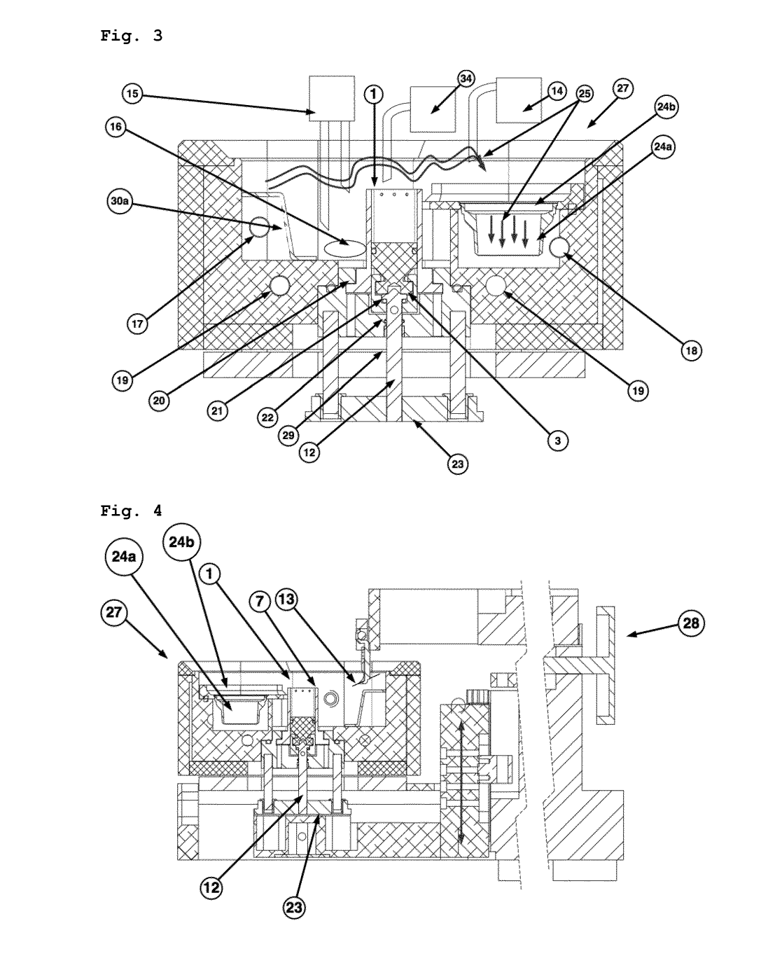

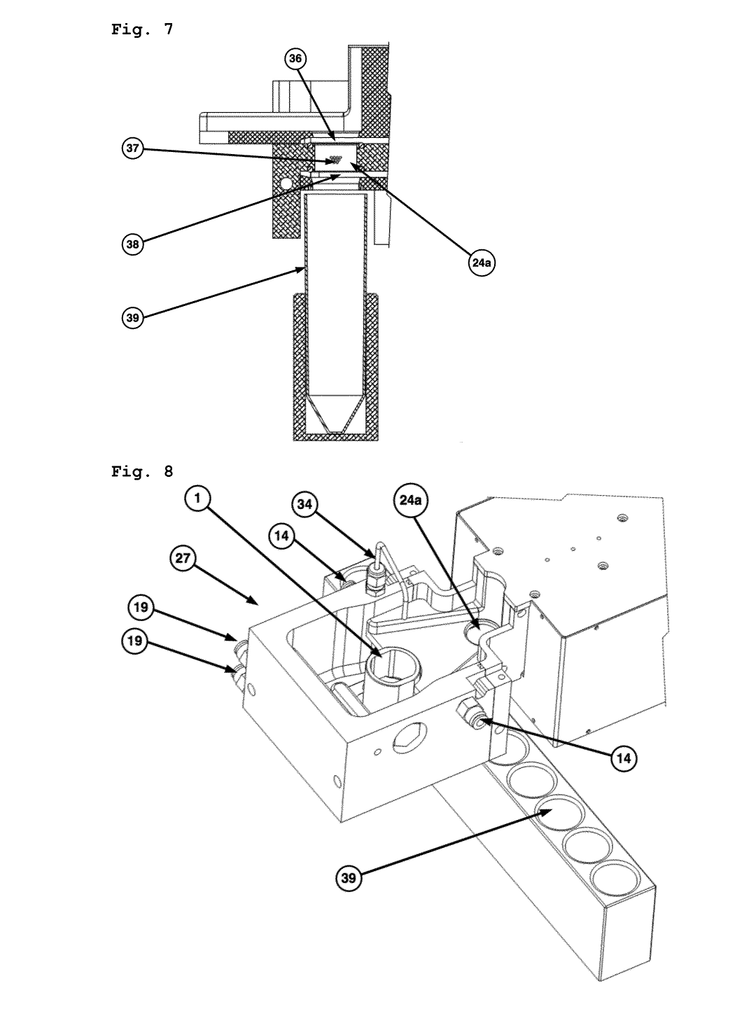

Referring to FIGS. 3, 4, 5, 7 and 8, the disclosure also provides a microtome chamber (27) adapted to accommodate the sample holder (1), as defined hereinbefore, comprising:

a sample holder receptacle (20),
a flow inlet (17) and outlet (18),
means to connect (23) the microtome chamber to a microtome (28),
means to allow a connection between a micrometer drive (12) and the micrometer drive connection means of the plunger, as described hereinbefore (10a and 10b, as shown in FIG. 2A).
the microtome chamber being characterized in that it comprises:
means (30a and 30b) to generate a vectorized flow (25), and
sample collection means (24a and 24b)

In a particular embodiment, the sample holder receptacle (20) is compatible with the connection means of the shaft of the sample holder, as defined hereinbefore (4 in FIG. 2A).

In another particular embodiment, the sample holder receptacle together with the sample holder connection means form a connector, which is defined hereinbefore. The connector ensures a close fit between the sample holder and the microtome chamber, thereby securing the sample holder, and in particular the shaft of the sample holder at a fixed position/orientation in the microtome bath. Since the lengths of shafts from different sample holders are identical, the shaft connector also ensures that the top end of a connected sample holder (7) is always at the same position in relation to the knife (13).

The disclosure further provides a microtome comprising a sample holder, according to the disclosure. Furthermore, the use of a sample holder, according to the disclosure, is envisioned by the disclosure.

In yet another particular embodiment, the disclosure provides a microtome chamber (27) comprising:

a sample holder (1), which is in a fixed position during cutting;
means (30a and 30b) to generate a directional flow (25); and
a sample collection chamber (24a) comprising a sample inlet (36).

A fixed position of the sample holder during cutting refers to a fixed position in relation to the microtome chamber, thus excluding, e.g., rotational or translational movement in relation to the microtome knife during cutting. It is evident that movement between cutting steps is allowed, e.g., to raise or lower the sample or remove/replace the sample holder. In other words, the sample holder is stationary during cutting. As such, it retains the sample in a fixed position with respect to the microtome chamber.

The microtome chamber, as described herein, is particularly useful in a vibratory microtome and accordingly, in a particular embodiment, the microtome chamber, as described herein, is a vibratome chamber. In another particular embodiment, the microtome chamber of the disclosure contains a cavity, herein also referred to as the microtome bath, which can be filled with an appropriate liquid, such as normally used in the specimen tray of a vibratory microtome. Any liquid can be used, but typically, water or a buffered medium is used in a microtome bath. The sample holder receptacle, as defined hereinbefore, is located in this microtome bath. Hence, during typical operation, the sample holder is located in the bath, which is, at least partially, filled with liquid, submerging the specimen during cutting operation. The flow inlet (17) and flow outlet (18), according to the disclosure, not only allow, respectively, filling and emptying of the microtome bath, but may also be used in controlling the fluid level in the cavity and in participating in the vectorized flow, in the instance the flow outlet will be positioned in close proximity to the sample collection chamber (24a).

In another embodiment, the microtome chamber, according to the disclosure, is further characterized in that it comprises means to regulate the fluid level (15) in the microtome bath. Evidently, all available means to regulate a fluid level can be used. Examples of fluid level regulation means include, but are not limited to, one or more elements selected from the group comprising:

a fluid level detection system, such as a float switch or any electric, optical, or weight-based level detector;
a pump;
a suction device;
a variable flow inlet;
a variable flow outlet; and
a chamber with a variable volume incorporated in a closed fluid circuit.

As such, the means to regulate the fluid level in the microtome bath are either an integrated part of the fluid circuit controlling the fluid in- and outflow of the bath through the in- (17) and outlet(s) (18); or an independent system (15), in particular a chamber with a variable volume incorporated in a closed fluid circuit.

In another embodiment, the microtome chamber, according to the disclosure, further comprises temperature control means (19). Any method that allows controlling the temperature of the microtome chamber and/or its contents can be used. Examples are a microtome chamber with a double wall, wherein a temperature controlled fluid or gas circulates; electrical heating and/or cooling of the microtome chamber; means to bring the microtome chamber into contact with a warm or cool material, such as ice. In a particular embodiment, the temperature control means consist of a microtome chamber with a double wall, wherein a temperature controlled fluid is circulated.

The vectorized or directional flow (25) in the microtome chamber, according to the disclosure, is useful for displacing a cut section from the region around the top of the sample holder. The flow can be created in several ways. Typically, this involves distributing the incoming liquid flow. Means to create a vectorized or directional flow include one or more of the following features; the use of a plurality of flow inlets, spaced apart at regular intervals; the use of a laminar flow nozzle; the use of a perforated wall (30a and 30b); and the use of fins, ribs, slopes, or other elements at the surface of the microtome bath that guide the movement of the fluid through the cavity. In a particular embodiment, the means to generate a vectorized or directional flow, according to the disclosure, comprises a perforated wall. The perforated wall can be placed anywhere between the flow inlet and the sample holder. Perforations (30b) may have any form, including circles, squares, rectangles, slits, etc.

To prevent that the cut section sticks to the knife and is therefore not transported by the vectorized flow, a spray system (34) is provided in a particular embodiment of the disclosure to flush a cut section from the knife (13). When a section is removed from the sample without the use of a knife, for example, in a laser microtome, the spray system is adapted to flush the cut section from the top of the sample. The spray system sprays a liquid or gas with sufficient force to displace the cut section. In particular, a liquid is used. In particular, this liquid is the same liquid as used in the microtome bath.

As defined hereinbefore, the microtome chamber, according to the disclosure, provides sample collection means (24a and 24b), which allows trapping the section that is displaced by the vectorized flow. This further prevents that cut sections interfere with the staining, imaging and cutting processes. In particular, the sample collection means comprises a sample collection chamber (24a) comprising a sample inlet (36). In another particular embodiment, the sample collection chamber further comprises a fluid outlet (37). Such a fluid outlet allows that a directional flow (25) flows through the sample collection chamber and proceeds to the flow outlet, thus allowing transport of a cut section from the sample holder (1) to the sample collection chamber (24a). To prevent entrapment of the cut section into the fluid outlet, the fluid outlet (37) may comprise a filter. In a particular embodiment, the fluid outlet consists of a filter. Any filter can be used that allows fluid to pass through, but prevents transfer of cut sections. Filters can, e.g., be one or more holes in one or more walls of the sample collection chamber, or a mesh that is placed at the fluid outlet.

In another particular embodiment, the sample collection chamber (24a), according to the disclosure, consists of a mesh well. In particular, the mesh well is positioned above the flow outlet (18) to ascertain that the vectorized flow that transports the cut section passes through the mesh well. The mesh well is reversibly connected to the microtome chamber, allowing easy replacement. Any reversible connection can be used, including a twist-lock connector, a friction lock, a screw-threaded connector, a magnetic connector, and a connector that uses coupling pins. In a particular embodiment, the connection between the mesh well and the microtome chamber is a twist-lock connector. On the one hand, when the sections are not retained for further processing, the mesh well serves as a collection bin for cut sections. When the mesh well is full, the mesh well can be replaced with an empty mesh well. On the other hand, when sections need to be preserved for subsequent processing, the mesh well is constructed to support one or more sections without damaging them. The sample collection means of the disclosure are especially useful for collecting very thin sections without damaging them. Sections have a thickness of 5 to 2000 micrometers; in particular, they have a thickness of 5 to 50 micrometers, more in particular from 5 to 25 micrometers. Removal of the mesh well than ensures that sections can be kept for further processing. Replacement with a new mesh well allows collecting subsequent sections.

In a particular embodiment, the sample collection means comprises an identifier. Any identifier may be used, including a combination of one or more elements selected from the group comprising numbers, symbols, letters, barcodes, two-dimensional barcodes, and radio-frequency identification tags.

In yet another particular embodiment, the sample collection means further comprises a funnel (24b). The funnel is reversibly connected to the microtome chamber, allowing easy replacement. Any reversible connection can be used, including a twist-lock connector, a friction lock, a screw-threaded connector, a magnetic connector, and a connector that uses coupling pins. In a particular embodiment, the connection between the funnel and the microtome chamber is a magnetic connector. This funnel directs the vectorized flow, and, thus, sections displaced by the flow, to the sample collection chamber. In another particular embodiment, the funnel supports the sample collection means within and above the flow outlet of the microtome chamber. In the embodiment, the sample collection chamber is only indirectly, and through the funnel, connected to the microtome chamber. In this last embodiment, the funnel is connected to the microtome chamber and the funnel comprises receptacles to support the sample collection chamber that is placed inside.

In another embodiment, the microtome chamber, according to the disclosure, comprises means to replace the sample collection chamber with a new sample collection chamber in an automated manner. In a particular embodiment, a carrousel can be integrated in the microtome chamber. In another particular embodiment, the carrousel is removably attached to the microtome chamber. This carrousel (31) can hold two or more sample collection chambers, such as mesh wells (24a); in particular from 6 to about 12 mesh wells, as defined hereinbefore, with one of the mesh wells located in the microtome bath, above the flow outlet. When needed, the part of the carrousel that contains the mesh wells rotates, thereby replacing the mesh well above the flow outlet with the next mesh well in the carrousel. In another particular embodiment, the carrousel can further hold a funnel (24b), as defined hereinbefore, for each mesh well. In a particular embodiment, the mesh well is connected only indirectly and through the funnel, to the carrousel. In this last embodiment, the funnel is connected to the carrousel and the funnel comprises support members to support the mesh well that is placed inside. In yet another particular embodiment, the carrousel can hold from 6 to about 12 funnels that support the mesh wells. In particular, the funnels are reversibly connected to the carrousel, for example, through the use of magnets, and support a mesh well that is placed inside the funnel. A typical operating step may involve the following iterative steps:

a section is cut from the sample,
it is transported by the vectorized flow through a funnel into the carrousel onto the mesh well that is placed inside the funnel,
the carrousel rotates one step, thereby removing the mesh well that contains the section from the vectorized flow and placing the next mesh well from the carrousel into the vectorized flow.

In another particular embodiment, part of the carrousel, as described hereinbefore, can be removed and replaced. This part contains all the connections to the funnels and/or mesh wells. Removal of this part provides an easy manner to remove all mesh wells from the carrousel at the same time and to place more than one empty mesh well at the same time into the carrousel.

In yet another particular embodiment, a part of the microtome chamber, according to the disclosure, can be removed and replaced. This part comprises the sample collection means. Removal of this part allows a user to replace the sample collection means with the means to replace the sample collection chamber with a new sample collection chamber in an automated manner, as defined hereinbefore. Therefore, in this particular embodiment, a user can choose to construct a microtome chamber with one sample collection chamber or a microtome chamber with an automated system to replace sample collection chambers.

In a further aspect, a sample collection chamber, according to the disclosure, comprises a sample outlet (38). In one embodiment, the sample outlet may be the same as the sample inlet (36), such as, e.g., in a mesh well. In another embodiment, the sample outlet differs from the sample inlet. In yet another particular embodiment, opposing walls of the sample collection chamber comprise the sample inlet and sample outlet. In this embodiment, one or more fluid outlets (37) may be positioned in the walls between the walls comprising the sample inlet and outlet. Furthermore, the fluid outlet may be the same as the flow outlet, which indicates that all the fluid from the directional flow exits the microtome bath through the fluid outlet.

In another particular embodiment, the microtome chamber, according to the disclosure, comprises means to open and close the sample inlet (36). In another embodiment, the microtome chamber comprises means to open and close the sample outlet (38). In yet another embodiment, the microtome chamber, according to the disclosure, comprises means to open and close the sample inlet and sample outlet. In a preferred embodiment, the microtome chamber comprises means to open and close the sample inlet and/or sample outlet in an automated manner, in particular in a coordinated manner. That is, in coordination with the slicing operation of the microtome. In a further embodiment, the microtome chamber, according to the disclosure, comprises a space to position a sample container (39) in close proximity to, in particular next to, the sample outlet, to receive the sample section upon opening of the sample outlet. Such a sample container may be used to collect one or more sample sections before a new sample container is put in place that can be used to collect subsequent sections. It is beneficial that the replacement of sample containers is performed in an automated manner. This allows for the collection of multiple cut sections without the need for the operator to remain with the microtome chamber of the disclosure while in use. A particular advantage of the embodiments of the disclosure that allow the translocation of the cut section from a sample collection chamber to a sample collection container, is that it allows the collection of several sections within one receptacle (i.e., the sample collection container), without the risk of clogging filter(s) that are present in the sample collection chamber.

In a preferred embodiment, the microtome chamber of the disclosure performs several sample cutting and section collection steps in an automated manner. A section is cut from a submerged sample holder (1) and, optionally, a spray system (34) flushes the section from the microtome knife. The cut section is dislodged from the knife and transported by the directional flow (25) towards the sample collection chamber (24a), wherein the sample inlet (36) is in the opened position and the sample outlet (38) is in the closed position. The cut section enters the sample collection chamber through the sample inlet and remains in the sample collection chamber. The fluid that carries the cut section exits the sample collection chamber through the fluid outlet (37) and progresses towards the flow outlet (18). In a preferably automated manner, the sample inlet is closed, thereby preventing the directional flow to further enter the sample collection chamber. The sample outlet (38) opens and the cut section(s) proceed to the sample collection container (39). The sample collection container is replaced, preferably in an automated manner, the sample outlet closes and the sample inlet opens; thus allowing one or more repeats of the above steps. Evidently, the here-described operation is fully compatible with other embodiments of the disclosure, including, but not limited to, imaging and/or staining of the sample.

Accordingly, the disclosure provides a method to automate the processing of a sample in a microtome, comprising the following steps:

a) providing a sample in a sample holder, wherein the sample holder is in a fixed position during step b);
b) cutting a thin section from the surface of the sample; and
c) using a directional flow to transport the section into a sample collection chamber.

In another embodiment, the disclosure provides a method to automate the processing of a sample in a microtome comprising a microtome chamber, according to the disclosure, the method comprising the following steps:

a) providing a sample in a sample holder, wherein the sample holder is in a fixed position during step b);
b) cutting a thin section from the surface of the sample; and
c) using a directional flow to transport the section into a sample collection chamber.

In a particular embodiment, the method to automate the processing of a sample further comprises step d) replacing the sample collection chamber with a new sample collection chamber, optionally in an automated manner.

In another particular embodiment, the method to automate the processing of a sample further comprises steps:

d) closing the sample inlet of the sample collection chamber;
e) opening the sample outlet of the sample collection chamber; and
f) collecting the section into a sample collection container.

In yet another particular embodiment, the method to automate the processing of a sample further comprises imaging the surface of the sample before or after step b). In a particular embodiment, the method to automate the processing of a sample further comprises:

lowering the fluid level in the microtome chamber until the fluid level is located below the surface of the sample before the imaging; and
raising the fluid level until the fluid level is located above the surface of the sample after the imaging.

As will be evident to the skilled artisan from reading the different embodiments of the present disclosure, the method to automate the processing of a sample is further characterized in that the cut section is continuously in contact with fluid during the procedure. More in particular, the cut section is kept in fluid in the sample collection chamber and/or sample collection container. This excludes the risk that the cut section is damaged during storage in the sample collection chamber and/or sample collection container due to drying.

It is a further objective of the present disclosure to provide a microtome comprising a microtome chamber, according to the disclosure. In another embodiment, the present disclosure provides a vibratome comprising a microtome chamber, according to the disclosure. In yet another embodiment, the disclosure provides a microtome, in particular a vibratome, comprising a microtome chamber, according to the disclosure and a sample holder, according to the disclosure. Evidently, the use of a microtome chamber, according to the disclosure, is envisioned by the present disclosure, in particular the use of a microtome chamber, according to the disclosure in a microtome, more in particular in a vibratome.

In a particular embodiment, the microtome chamber, according to the disclosure, comprises sample imaging means. In particular, the sample imaging means are oriented such that the sample in the sample holder (1) of the microtome chamber can be imaged. Any imaging means known in the art can be used, particularly imaging means that allow the analysis of stained or unstained biological samples. A skilled person knows what can be selected from the known imaging techniques. As an example, in a particular embodiment, fluorescence imaging, such as two-photon excitation microscopy, can be used to image and analyze a fluorescently stained sample. The imaging means may be automated so that a predefined number of images are captured after one or more sections have been removed from the surface of the sample. In a particular embodiment, captured images are transferred to a processing unit, such as in a computer. This allows further analysis of the captured images, e.g., for the automatic calculation of sample parameters or to generate a three-dimensional image of the sample.

In another embodiment, the microtome chamber, according to the disclosure, comprises means to enable the exchange of fluids within the sample holder. The means are compatible with the fluid exchange means of the sample holder, and allow a fluid-tight connection between the sample holder and an external fluid exchange system to perform all the processing steps for embedding a sample, diffusion of liquids into the sample, or staining the surface of the sample.

In a particular embodiment, the microtome chamber comprises one or more connection tubes (33). These connection tubes are compatible with the one or more holes in the shaft (32), as defined hereinbefore. In a particular embodiment, a sealing ring is attached either to the ends of each tube, or to each hole in the sample holder. When connecting a tube from the microtome chamber to a hole in the sample holder, the sealing ring prevents leakage. In another particular embodiment, the tube is made from a rigid material, for example, rigid plastic or metal. In particular, on or more of the rigid tubes can be displaced in an automated manner from the wall of the chamber to connect with one or more of the holes in the sample holder. In particular, the rigid tubes can slide out of the wall of the chamber. In another particular embodiment, the sample holder comprises two opposite holes and the microtome chamber comprises two tubes. In this last embodiment, one tube is connected to a pump to pump a liquid from the external fluid exchange system into the sample holder, the other tube is connected to a suction device to suck a liquid from the sample holder to the external fluid exchange system. In this manner, a flow can be created on top of the sample for staining and washing the surface of the sample.

The fluids exchange system can be used to transport liquids via the microtome chamber to the sample holder. These liquids may be delivered from reservoirs that are placed inside or outside of the microtome chamber. Typically, the liquids are transported using one or more pumps and/or suction devices. The devices can be controlled manually or in an automated manner by a processing unit. In a particular embodiment, the fluids exchange system can be used for sample preparation, such as for diffusing one or more liquids into the sample, or for embedding a sample in a gelling or hardening liquid. In another particular embodiment, the fluids exchange system can be used for staining the surface of a sample. As is known by a person skilled in the art, the staining can comprise one or more of the following steps, in any order: bringing a staining fluid into contact with the surface, incubating a fluid onto the surface, washing or rinsing the surface.

Typical staining operation may involve the following iterative steps:

lowering the fluid level below the top of the sample holder,
lowering the plunger onto which a sample is immobilized, thereby creating an empty cavity in the shaft above the surface of the sample,
connection of the fluids exchange system,
transport by the fluids exchange system of a solution of a stain in the cavity,
incubating the staining solution on the surface of the sample,
removal of the staining solution by the fluids exchange system,
washing the sample surface using the fluids exchange system,
imaging the surface of the sample,
raising the fluid level to submerge the sample,
raising the plunger,
removing a thin section from the surface of the sample with a microtome knife.

As is known by a person skilled in the art, typical operation can be performed using a variety of adaptations of the above steps, including removal or addition of one or more steps and changing the order of one or more steps.

In another embodiment, the microtome chamber, according to the present disclosure, is further characterized in that it comprises means to recognize an identifier on the sample holder, as defined hereinbefore. These means may include a barcode, two-dimensional barcode or radio-frequency identification tag reader that recognizes an identifier on the sample holder. The microtome chamber further communicates this information to a processing unit.

In yet another embodiment, the microtome chamber, according to the present disclosure, is further characterized in that it comprises means to recognize an identifier on the sample collection means, as defined hereinbefore. These means may include a barcode, two-dimensional barcode or radio-frequency identification tag reader that recognizes an identifier on the sample collection means. The microtome chamber further communicates this information to a processing unit.

The disclosure provides means (23) to connect the microtome chamber to a microtome (28). In principle, any means to securely attach the microtome chamber to a microtome can be used. One or more reversible or irreversible connections can be used. Reversible connections include a twist-lock connector, a friction lock, a screw-threaded connector, a magnetic connector, and a connector that uses coupling pins. Irreversible connection methods include welding, melting, and irreversible compression connections.

The microtome chamber, according to the present disclosure, provides means to allow a connection between a micrometer drive (12) and the micrometer drive connection means of the plunger (10a and 10b) of the sample holder, as defined hereinbefore. The means to allow a connection may include securing a micrometer drive that is placed inside the microtome bath, or they may include a passage (29) through which the micrometer drive can reach the plunger. They may further, optionally, include sealing means (21) to prevent leakage from the microtome bath when the sample holder is removed. Additionally and optionally, they may include bearings (22) to constrain the orientation of the movement of the micrometer drive. For proper operation, the micrometer drive should comprise connection means to interact with the micrometer drive connection means of the plunger.

1. A microtome chamber comprising:
a sample holder that is in a fixed position during cutting;
means for generating a directional flow; and
a sample collection chamber comprising a sample inlet.

2. The microtome chamber according to claim 1, wherein said sample collection chamber further comprises a fluid outlet.

3. The microtome chamber according to claim 2, wherein said fluid outlet comprises a filter.

4. The microtome chamber according to claim 1, further comprising means for replacing said sample collection chamber with a new sample collection chamber in an automated manner.

5. The microtome chamber according to claim 1, wherein said sample collection chamber comprises a sample outlet.

6. The microtome chamber according to claim 5, further comprising means for opening and closing the sample inlet and said sample outlet.

7. The microtome chamber according to claim 5, further comprising a space to position a sample container next to the sample outlet to receive the sample section upon opening of said sample outlet.

8. The microtome chamber according to claim 1, wherein said means to generate for generating a directional flow comprise a perforated wall.

9. The microtome chamber according to claim 1, further comprising means for regulating the fluid level in said microtome chamber.

10. The microtome chamber according to claim 1, further comprising means for controlling the temperature.

11. The microtome chamber according to claim 1, further comprising means for removing surface and/or bottom debris.

12. The microtome chamber according to claim 1, further comprising means for exchanging fluids within the sample holder.

13. The microtome chamber according to claim 1, wherein said sample holder is removable.

14. The microtome chamber according to claim 1, further comprising means for recognizing an identifier on the sample holder.

15. The microtome chamber according to claim 1, further comprising means for recognizing an identifier on the sample collection chamber.

16. The microtome chamber according to claim 1, further comprising means for sample imaging.

17-20. (canceled)

21. A method of using the microtome chamber of claim 1 to automate processing of a sample in a microtome comprising the microtome chamber, said method comprising the following steps:
a) providing a sample in a sample holder wherein said sample holder is in a fixed position during step b);
b) cutting a thin section from the surface of said sample; and
c) utilizing a directional flow to transport said section into a sample collection chamber.

22. The method according to claim 21, further comprising step d) replacing said sample collection chamber with a new sample collection chamber.

23. The method according to claim 21, further comprising:
d) closing the sample inlet of said sample collection chamber;
e) opening the sample outlet of said sample collection chamber; and
f) collecting said section into a sample collection container.

24. The method according to claim 21, further comprising imaging the surface of said sample.

25. The method according to claim 21, further comprising:
lowering the fluid level in the microtome chamber until said fluid level is located below the surface of said sample before said imaging; and
raising said fluid level until said fluid level is located above the surface of said sample after said imaging.

26. A sample holder comprising:
a plunger with a sample anchor,
a shaft which is open-ended at an upper end and at a lower end, and that in sealing relation encases said plunger, wherein the shaft comprises connection means, and
fluids exchange means.

27. The sample holder according to claim 26, further comprising means for preventing fluid leakage between said plunger and said shaft.

28. (canceled)

29. The sample holder of claim 26, wherein the connection means are located at the lower end of said sample holder.

30. The sample holder of claim 26, wherein the connection means are connected to or are part of the shaft and comprise one or more elements selected from the group consisting of a thread, a protrusion, and a notch.

31. The sample holder according to claim 26, wherein said sample anchor comprises a face for immobilizing a sample to the plunger.

32. (canceled)

33. The sample holder of claim 31, wherein said sample anchor comprises a mesh that is connected to the top end of said plunger with one or more spacers.

34-35. (canceled)

36. The sample holder according to claim 26, wherein the plunger and said shaft are not cylindrical.

37. The sample holder according to claim 26, wherein said plunger is connected to or comprises means for interacting with a micrometer drive, said means for interacting with a micrometer drive comprising one or more elements selected from the group consisting of a thread, a protrusion, and a notch.

38. The sample holder of claim 26, further characterized in that it comprises an identifier.

39. The sample holder according to claim 26, wherein the fluids exchange means are located at the upper region of said sample holder.

40. A method of analyzing a submerged sample in a microtome comprising the sample holder of claim 26 and a microtome chamber, said method comprising iterative steps of:
lowering the fluid level in the microtome chamber until the fluid surface is located below the sample,
staining the surface of the sample,
imaging said surface,
raising the fluid level in the microtome chamber until the fluid surface is located above the sample, and
removing a thin section from the surface of the sample,
wherein the sample is substantially constantly submerged throughout the method.

41. A method of using the sample holder of claim 26 to analyze a sample, the method comprising iterative steps of:
staining the surface of the sample,
imaging said surface, and
removing a thin section from said surface.

42-44. (canceled)
